(19) United States
(12) Patent Application Publication
(10) Pub. No.: US 2025/0383977 A1
(43) Pub. Date: Dec. 18, 2025

(54) INTERACTIVE ELEMENT EVALUATION

(71) Applicant: ServiceNow, Inc., Santa Clara, CA (US)

(72) Inventors: Andriy Blazhiyevskiy, Danville, CA (US); Gopi Veeranki, Hyderabad (IN); Jayasree Veeraghanta, Hyderabad (IN)

(21) Appl. No.: 18/741,172

(22) Filed: Jun. 12, 2024

(51) Int. Cl. G06F 11/36; G06F 8/38

(52) U.S. Cl. CPC G06F 11/3698; G06F 8/38

(57) ABSTRACT

An indication of a user interface element associated with corresponding web content is received from a client. An identifier associated with the user interface element based at least in part on one or more attributes associated with the user interface element is determined. A specification of a code file and an operation is received. Program code to perform the operation on the user interface element referenced by the identifier is generated for the code file.

### BACKGROUND OF THE INVENTION

As web applications continue to offer expanded functionality, their accompanying client-side documents continue to grow in complexity and size. A client-side document may include hundreds or even thousands of different web elements, each potentially bound to different backend server functionality. During the development of a web application, uniquely identifying an individual web element in a client-side document, such as an element corresponding to a particular button or form, is often required to determine the element's corresponding server-side programming code. However, uniquely identifying an instance of a web element among the other elements in a client-side document is an increasingly challenging task. Therefore, there exists a need for an efficient workflow tool that enables developers to associate an identified web element easily and repeatedly with its backend server functionality.

### BRIEF DESCRIPTION OF THE DRAWINGS

Various embodiments of the invention are disclosed in the following detailed description and the accompanying drawings.

FIG. 1 is a block diagram illustrating an embodiment of an interactive web element evaluation platform for web applications.

FIG. 2 is a block diagram illustrating an embodiment of a client device configured for the evaluation of web application elements.

FIG. 3 is a block diagram illustrating an embodiment of a web applications platform service.

FIG. 4 is a flow chart illustrating an embodiment of a process for evaluating an element of a hosted web application.

FIG. 5 is a flow chart illustrating an embodiment of a process for determining a unique identifier for locating an element of a hosted web application.

FIG. 6 is a flow chart illustrating an embodiment of a process for selecting a set of attributes for identifying an element of a web application.

FIG. 7 is a flow chart illustrating an embodiment of a process for modifying the behavior of an identified web application element.

FIG. 8 is a flow chart illustrating an embodiment of a process for evaluating an element of a hosted web application.

FIG. 9 is a functional diagram illustrating a programmed computer system for the evaluation of web application elements.

FIG. 10 is a diagram illustrating an embodiment of a user interface for an element evaluation browser extension.

FIG. 11 is a diagram illustrating an embodiment of a user interface for an element evaluation browser extension.

FIG. 12 is a diagram illustrating an embodiment of a user interface for an element evaluation browser extension.

FIG. 13 is a diagram illustrating an embodiment of a user interface for an element evaluation browser extension.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Interactive web element evaluation is disclosed. For example, using the disclosed techniques and systems, a user such as a web developer or engineer can interact with and modify the behavior of elements of a web application. Once modified, the element's new behavior can be evaluated. The modifications to the element can be performed interactively by a developer from a web client, such as a web browser configured with an element evaluation extension. For example, when accessing a web application from a browser, a developer selects a desired web element for identification. Using a configured browser extension, the selected web element is uniquely identified by its corresponding set of unique attribute values. Once uniquely identified, a unique identifier for the desired web element is determined. The unique identifier is provided to the web application's backend service and is used to bind the web element within a server-side programming context. From within the web application and utilizing the browser extension, server-side programming code enabling requested operations or functionality for the element can be automatically generated based on the established binding. The generated programming code can be used to implement web application functionality as well as to automate test cases specific for the desired element.

As set forth, the disclosed web element evaluation platform and techniques enable users including web developers and engineers to easily and interactively evaluate web elements of a web application from within a client browser. For example, while accessing a web application, a user can select one of the many web elements used to implement the web application, associate a new operation or behavior with the selected element, and evaluate the element using the new operation. By attaching a new operation to the element, the evaluation of the new operation can be used to test and validate the element, such as validating the correctness of values associated with the web element and/or the functionality of the element. The requirement to test and validate software prior to deployment is a common and standard practice, however, the ability to validate a single and specific web element is challenging and requires significant technical knowledge, resources, and time, particularly for modern web applications that can be built using hundreds (or even more) of different web elements. For example, in order to uniquely identify and locate a web element within client-side web application code, a user typically is required to have a deep understanding of the web development process including an understanding of the associated web frameworks used to build the web application. Even with this knowledge, identifying a web element from the context of the client-side web application code is extremely time consuming, tedious, prone to error, and difficult to efficiently reproduce. Moreover, even once a web element is identified, such as by its placement in the Document Object Model, the deployed nature of the web application does not provide the user rapid access for modifying, testing, or validating its intended server-side functionality.

In consideration of these and other technical challenges, the disclosed solutions provide an efficient framework for performing client-side evaluation of web elements from within a client browser. The ability to access and validate the functionality of a web element remotely from a browser significantly increases the correctness of web applications without requiring additional technical knowledge, technical access to source code during the development process, and additional costly iterations of a development, deployment, and test cycle. As web applications continue to offer expanded functionality, the burdens in developing the applications continue to increase. The disclosed techniques and systems provide an efficient solution that enables developers to address these challenges both easily and repeatedly.

In some embodiments, an indication of a user interface element associated with corresponding web content is received from a client. For example, a developer selects a web element such as a user interface element from a web page. The selected element can correspond to a button, an image, a form, or another web component. In various embodiments, the developer selects the user interface element from within a client browser such as a web browser equipped with an element evaluation extension. In some embodiments, an identifier associated with the user interface element is determined based at least in part on one or more attributes associated with the user interface element. For example, attributes of the selected element are evaluated and used to uniquely identify the selected user interface element. In some embodiments, the determined attributes correspond to web page element attributes and/or may include a path, including a relative and/or full path, to the element. In various embodiments, the set of attributes is automatically determined and/or the user selects the set of attributes that are used to uniquely identify the selected user interface element. Based on the selected attributes, an identifier is generated that corresponds to the selected attributes and their values. In some embodiments, the identifier is a unique identifier for the selected user interface element and corresponds to a unique locator for identifying the element within the web content. The ability to determine a unique identifier based on element attributes from within a web browser allows users to easily and repeatedly locate a web element among the many others used in the web application.

In some embodiments, a specification of a code file and an operation are received. For example, using the element evaluation extension, the developer can specify a configuration specification for the selected user interface element. The specification can include a code file and operations to evaluate for the user interface element. The specification can be provided from within a web browser by a user such as via an element evaluation browser extension. Providing the specification remotely from the client browser allows the user to remain within the context of the web application and significantly improves the ability for the user to rapidly identify an element while also removing the requirement that the user has significant technical knowledge on web development and web application frameworks. In various embodiments, the referenced code file is stored along with the web application and is updated to include the specified operation. The operation can include functionality to perform based on a user interface element event including functionality that extends and/or tests the behavior associated with the user interface element. In some embodiments, program code to perform the operation on the user interface element referenced by the identifier is generated for the code file. For example, program code used to implement the specified operation is generated and stored within the specified code file. In various embodiments, the code file uses the identifier associated with the user interface element to bind the program code to the selected user interface element. By utilizing the referenced identifier associated with the element, the operation can be attached to and executed for the specific user interface element. This allows users to augment the functionality of a web element from within the browser web application, a process that traditionally requires multiple iterations of a costly development, deployment, and test cycle.

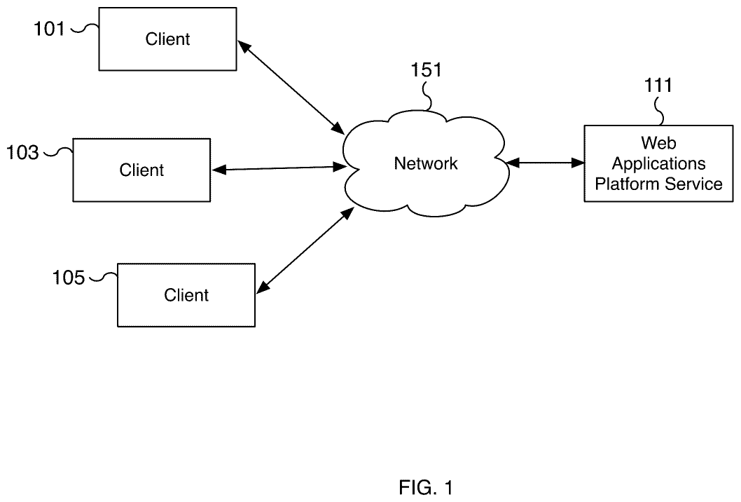

FIG. 1 is a block diagram illustrating an embodiment of an interactive web element evaluation platform for web applications. In the example shown, clients 101, 103, and 105 are network clients configured to access web content hosted by web applications platform service 111. Clients 101, 103, and 105 are communicatively connected to web applications platform service 111 via network 151. Network 151 can be a public or private network. In some embodiments, network 151 is a public network such as the Internet. Web applications platform service 111 provides web application services including services for hosting web applications and for interactively evaluating web elements of the hosted web applications. In various embodiments, the web applications are accessed via clients such as one of clients 101, 103, or 105. From within a client browser of clients 101, 103, or 105, a user can interactively identify and modify the behavior of a web element of a web application hosted by web applications platform service 111. For example, from within an element evaluation extension of a client browser associated with a client such as one of clients 101, 103, or 105, a user can interactively implement additional functionality for a web element such as a button, an image, a form, etc. In some embodiments, the implemented operations include automated test cases such as automated test operations to verify that the selected user interface element behaves and/or is associated with values as intended. In some embodiments, the implemented functionality that is bound to a selected web element is hosted by web applications platform service 111.

In some embodiments, clients 101, 103, and 105 are each a network client device for interfacing with digital workflow services hosted by web applications platform service 111. For example, each of clients 101, 103, and 105 can be configured with a browser to access services hosted by web applications platform service 111 including web application hosting and web application development services. In various embodiments, the supported services allow the users of clients 101, 103, and 105 to access, create, deploy, modify, and test (among other supported actions) the hosted web applications. The configured browsers of clients 101, 103, and 105 can each include an installed element evaluation extension that allows a user to interactively identify interested web elements from within the client browser. For example, an element evaluation extension can be installed to extend the default functionality of a browser to allow authorized users to identify and evaluate the functionality of a web application. In various embodiments, the installed element evaluation extension interfaces and/or connects with functionality associated with the hosted web application. For example, the installed element evaluation extension can interface with web applications platform service 111.

In some embodiments, web applications platform service 111 is a cloud server that offers functionality for managing web applications including functionality for hosting, developing, and testing web applications. The offered functionality can be performed from clients such as clients 101, 103, and/or 105 via the services offered by web applications platform service 111. For example, once a web application is hosted by web applications platform service 111, web applications platform service 111 offers element evaluation services which include the ability to identify an element within a web application and to extend and/or modify the functionality associated with the identified element. In some embodiments, the element evaluation services include the ability to bind and execute functionality hosted by web applications platform service 111 to a web application element by a determined identifier such as a unique locator identifier. The bound functionality can correspond to programming code received from a client and can be inserted into a program file hosted by web applications platform service 111. The newly bound functionality for an identified element of the web application can be executed when the appropriate trigger is initiated.

Although single instances of some components have been shown to simplify the diagram of FIG. 1, additional instances of any of the components shown in FIG. 1 may exist. For example, web applications platform service 111 may include one or more web application servers such as one or more web application hosting servers and one or more databases utilized by the web application hosting servers. Additionally, clients 101, 103, and 105 are example client devices for accessing and utilizing the services of web applications platform service 111. Although three clients are shown (clients 101, 103, and 105), many more additional clients can exist and access the services of web applications platform service 111. In some embodiments, components not shown in FIG. 1 may also exist.

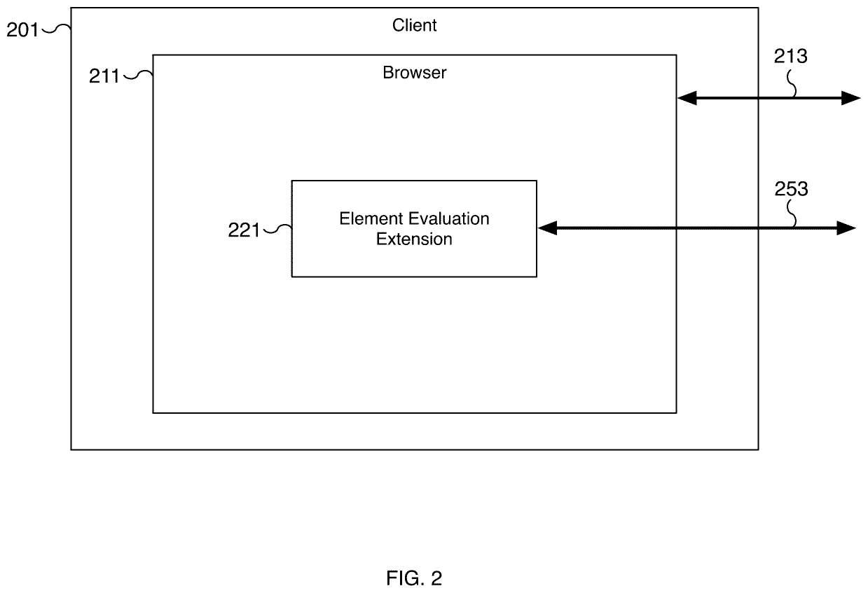

FIG. 2 is a block diagram illustrating an embodiment of a client device configured for the evaluation of web application elements. In the example shown, client 201 is a network client and includes browser 211 and element evaluation extension 221. In various embodiments, element evaluation extension 221 is a browser extension installed within the context of browser 211 and allows users to interact with a web application accessed via browser 211. Browser 211 and element evaluation extension 221 can establish network connections 213 and 253, respectively. Network connection 213 is utilized by browser 211 to access web applications such as cloud or web-based applications including Software-as-a-Service (SaaS) applications, and network connection 253 is utilized by element evaluation extension 221 to support the evaluation of a selected web application element. In some embodiments, network connections 213 and 253 may be a shared network connection. In some embodiments, client 201 is client 101, 103, and/or 105 of FIG. 1 and the accessed web application and associated evaluated web element are hosted by web applications platform service 111 of FIG. 1.

In some embodiments, client 201 is a network client such as a desktop computer, a laptop, a mobile device, a tablet, a kiosk, a voice assistant, a wearable device, or another network computing device. Client 201 may be managed by an IT operations group and can be configured for accessing applications including applications approved by the IT operations group. In various embodiments, client 201 may be used to access and test web applications including by modifying and instrumenting the functionality of specific selected web elements of a web application using browser 211 and via element evaluation extension 221. For example, client 201 is configured for the evaluation of web elements accessed via browser 211 at least in part by installing element evaluation extension 221 for browser 211.

In some embodiments, browser 211 is a web browser installed on client 201 and browser 211 is configured with element evaluation extension 221. Browser 211 may be configured with certain network and application access permissions and may be utilized to access and modify web applications including via element evaluation extension 221. In various embodiments, element evaluation extension 221 is a web browser extension and/or plug-in for evaluating elements of a web application. Element evaluation extension 221 can provide an interactive user interface for selecting an element of a currently active web application access via browser 211. Once selected, the element can be analyzed to determine an identifier such as a unique locator identifier. The determined identifier can be used for associating the element with its server-side functionality and to augment and/or modify the element's server-side functionality. For example, using element evaluation extension 221, a user can evaluate the functionality of a selected element including by testing the element's functionality and corresponding values. In various embodiments, element evaluation extension 221 can interface with a web driver associated with browser 211 for the automated testing of the selected element, for example, by executing verification program code assigned to the selected element. The selected element may be identified, at least in part, by one or more attributes associated with the element. For example, using element evaluation extension 221, a user can select from discovered attributes associated with the element to identify a unique set of attributes suitable for functioning as an element unique identifier.

In some embodiments, element evaluation extension 221 utilizes a network connection such as network connection 253 to access network resources such as an element evaluation service. The accessed services allow a user interacting with element evaluation extension 221 to modify back-end server-side functionality associated with a selected and identified element. For example, program code provided via element evaluation extension 221 can be uploaded via network connection 253 for a program file hosted by a web application service. The program code can be bound to the selected element and can be executed based on the configured program code triggers. In some embodiments, element evaluation extension 221 may be configured via one or more network connections such as network connections 213 and/or 253, and/or via another configuration interface.

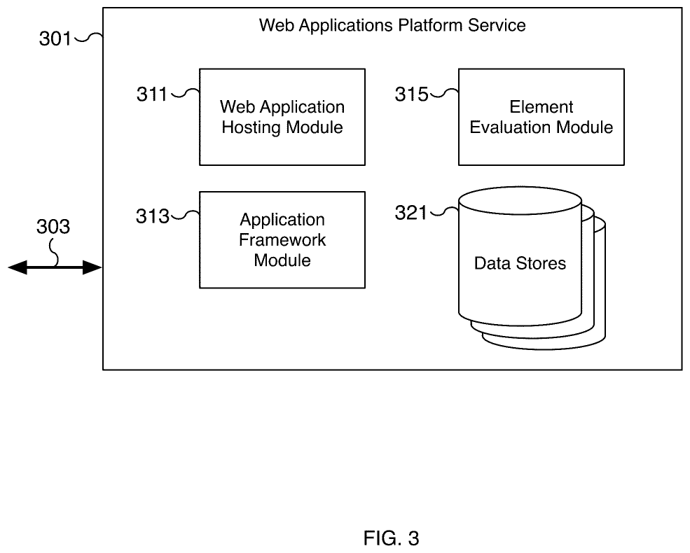

FIG. 3 is a block diagram illustrating an embodiment of a web applications platform service. In the example shown, web applications platform service 301 is a cloud-based service for managing web applications including for the hosting, development, and testing of web applications. Web applications platform service 301 communicates with remote clients via network connection 303 and includes multiple processing modules including web application hosting module 311, application framework module 313, element evaluation module 315, and one or more data stores 321. In some embodiments, web applications platform service 301 is web applications platform service 111 of FIG. 1 and/or the web applications platform service accessed via client 101, 103, and/or 105 of FIG. 1 and/or client 201 of FIG. 2.

In some embodiments, web applications platform service 301 includes multiple processing modules for performing one or more services associated with a web application. In embodiments, one or more of the modules shown may not exist and/or additional modules may exist. Moreover, the functionality of one or more of the modules may be merged into a single module and/or split out across multiple different modules. In the example shown, web application hosting module 311 provides data to and receives data from remote clients via network connection 303 for hosting an interactive web application. The hosted web application can utilize application framework module 313 for implemented core application framework functionality including modular and reusable web application components. When initiated, an element of the web application can be evaluated using element evaluation module 315. For example, element evaluation module 315 provides the server-side functionality to allow a remote client to associate specialized element server-side functionality with a selected element of a web application.

In some embodiments, web application hosting module 311 provides a processing module for deploying and hosting a web application. For example, web application hosting module 311 can handle infrastructure requirements for hosting and serving the web application to users. In various embodiments, the hosting services are offered and managed as a web service and management of the hosted application can be accessed via remote clients. In some embodiments, web application hosting module 311 provides support for data analytics including support for logging events, errors, and other relevant information associated with the web application. In some embodiments, the support includes real-time monitoring during the execution of the web application. In some embodiments, a web application hosted by web application hosting module 311 utilizes components of application framework module 313 to enable the functionality of at least portions of the web application and a data store such as data stores 321 for reading and writing data including persistent data. Additionally, a hosted web application can reference and utilize the element evaluation functionality of element evaluation module 315 to evaluate specific elements of the web application hosted by web application hosting module 311.

In some embodiments, application framework module 313 provides a processing module for web applications including the development of and hosting of dynamic and interactive web applications. Application framework module 313 can provide an organized structure for organizing web application functionality and may include pre-built and executable components for quickly adding web application functionality including support for interactive and dynamic actions. Some of the supported actions can further include user interface action as well as database or data store actions. In various embodiments, application framework module 313 provides developers with the ability to quickly create and test applications that utilize complex logic and data processing tasks as well as the ability to scale the application if needed. In some embodiments, various instances of components associated with application framework module 313 can utilize a data store such as data stores 321 for storing data such as preferences, temporary values, and/or persistent data. In some embodiments, element evaluation module 315 provides functionality to test and/or extend the functionality of components supported by and/or implemented with application framework module 313.

In some embodiments, element evaluation module 315 is a processing module for evaluating selected elements of a web application hosted by web application hosting module 311. In various embodiments, element evaluation module 315 offers the server-side functionality for inspecting an element and is utilized in connection with a client-side component such as an element evaluation browser extension. In some embodiments, the element evaluation browser extension is element evaluation extension 221 of FIG. 2. For example, element evaluation module 315 may receive element evaluation requests and in response can support the evaluation of the element including by binding additional server-side functionality to the element. The additional functionality can be executed based on trigger events, such as a page load or mouse click events, and may include automated testing and/or validation program code. In various embodiments, element evaluation module 315 utilizes network connection 303 to interface with the corresponding element evaluation browser extension running within a client browser.

In some embodiments, data stores 321 corresponds to one or more data stores for use by web applications platform service 301. For example, one or more data stores of data stores 321 can be used to store data including program files associated web application functionality. In some embodiments, data stores 321 are one or more remote databases and can include one or more distributed databases and/or one or more time-series databases. Data stores 321 can provide standard or standardized interfaces for accessing data including structured and/or semi-structured data for web applications. The data stored at data stores 321 can include persistent data and may include in-memory data stores. In various embodiments, data stores 321 can implement scaling techniques to support large volumes of data while maintaining high performance as well as authentication systems to limit the access to data stores 321.

In some embodiments, the functionality of web applications platform service 301 can be shared and/or distributed across one or more computer systems including one or more different computer servers, web application servers, database servers, and/or file servers, among other hardware computer systems. In various embodiments, web applications platform service 301 further stores configuration and management settings for web applications and/or clients in data stores 321.

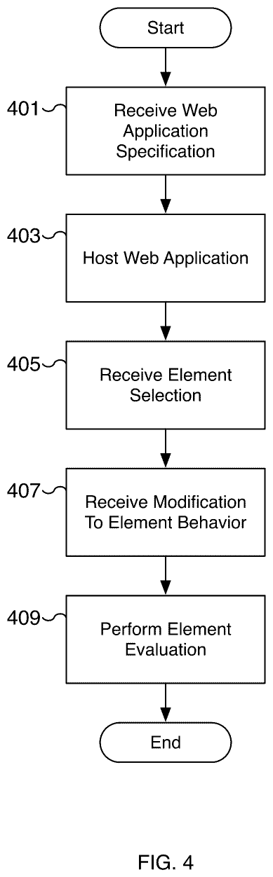

FIG. 4 is a flow chart illustrating an embodiment of a process for evaluating an element of a hosted web application. For example, using the process of FIG. 4, a web application can be created and hosted for access from a remote client. Individual elements of the web application can be evaluated from within the browser application of the remote client using an associated element evaluation browser extension. The element evaluation extension allows the user to evaluate and/or modify the server-side functionality associated with the element. In some embodiments, the process of FIG. 4 is used at least in part to automate the testing and validation of selected web elements of a web application. In some embodiments, the process of FIG. 4 is implemented as one or more web services by web applications platform service 111 of FIG. 1 and/or web applications platform service 301 of FIG. 3. In some embodiments, the remote client used to evaluate an element corresponds to clients 101, 103, and/or 105 of FIG. 1 and/or client 201 of FIG. 2.

At 401, a web application specification is received. For example, the specification for a web application to be hosted and deployed is received. In various embodiments, the specification corresponds to the functionality such as the program code for the web application and related configuration settings for deploying and running the web application. The specification can be created using web developer tools including a user interface builder to select and configure the components to use within the web application. Configuration settings received as part of the received web application specification can include settings related to loading and executing the web application including settings for components or elements of the web application and their associated prioritization values. Other configuration settings can include application framework references, web driver configurations, and related project files and/or paths or repositories. In some embodiments, selected components or elements for use in the web application are sourced from a web application framework and may rely on one or more shared component libraries. In various embodiments, the received specification is used to manage the web application including for action related to creating, generating, building, and/or deploying the web application.

At 403, a web application is hosted. For example, the web application corresponding to the web application specification received at 401 is deployed and hosted thereby providing user access to the web application from remote clients and their browsers. In various embodiments, the hosting of the web application includes providing the hardware and software infrastructure to deploy and operate the web application. In some embodiments, the web application is hosted along with services to support web drivers, such as drivers associated with a framework to automate the testing and validation of the web application and its features, and a service to support the evaluation of elements of the web application. In various embodiments, the hosted web application can be accessed via remote clients from within a browser application. Once accessed, clients can inspect elements using a configured element evaluation browser extension.

At 405, an element selection is received. For example, a user can select and identify a specific element of the web application for evaluation using an element evaluation extension configured for the client browser. The element can be selected based on attributes associated with the element and a unique identifier can be determined for the element. At 405, the element selection is received, and the received information associated with the selection can include a unique identifier such as a unique locator identifier for the element. In various embodiments, the unique identifier can be determined based on a set of attributes and/or path associated with the web element.

At 407, a modification to the behavior of the element is received. For example, the behavior associated with the element can be modified and at 407, the modification for the newly intended behavior is received. In some embodiments, the modification includes program code that is installed in an associated program file for execution. For example, a modification can include automated testing and validation functionality that is executed when an event bound to the element is triggered, such as a page load event, a mouse click event, a hover event, etc. In some embodiments, the received modification corresponds to server-side functionality and is configured for the selected element by bounding the functionality using a determined identifier for the element. In some embodiments, the determined identifier is received at 405 and/or 407 and corresponds to a unique locator for the element.

At 409, an element evaluation is performed. For example, the evaluation of functionality associated with the element is performed and, if configured, may be performed in response to a configured event being triggered. The evaluation can include execution of the functionality implemented by the modification received at 407. For example, the evaluation of the element can include executing functionality implemented by program code received at 407. In various embodiments, to correctly execute the configured functionality, the element is identified based on its determined identifier and the binding created using the identifier at 407. In some embodiments, the results are provided to the client such as via the web browser of the client and/or within the element evaluation extension configured for the client browser.

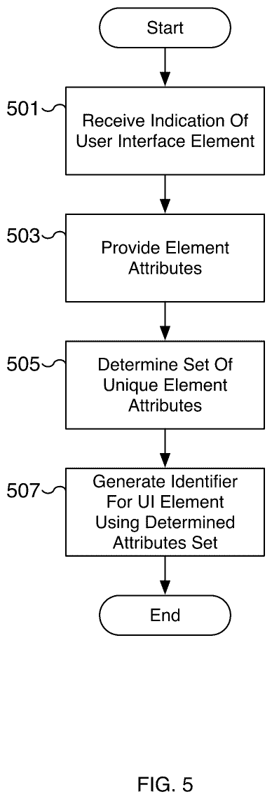

FIG. 5 is a flow chart illustrating an embodiment of a process for determining a unique identifier for locating an element of a hosted web application. For example, using the process of FIG. 5, a user such as a web developer or engineer can interactively and dynamically identify web elements from within a web application. The identification can be performed in real time while navigating the web application from within a client browser. In various embodiments, the identification is performed using an element evaluation extension. For example, a user can be guided using an interactive user interface for determining a unique identifier used to uniquely locate the element among the other elements or components of the web application. Although the steps of FIG. 5 may be at times described with respect to a user interface element, the process is not limited to elements with or associated with a user interface and is applicable to other types of web elements of the web application. In some embodiments, the process of FIG. 5 is performed at 405 of FIG. 4. In some embodiments, the process of FIG. 5 may be performed at least in part by an element evaluation browser extension such as element evaluation extension 221 of FIG. 2 and/or by an element evaluation module such as element evaluation module 315 of FIG. 3.

At 501, an indication of a user interface element is received. For example, an indication provided from a client for a user interface element of the web application is received. In various embodiments, the element is associated with corresponding web content of the web application. For example, the element can be associated with a web button, form, dialog box, chart, image, etc. and associated values of the web application. In some embodiments, the user interface element corresponds to a custom web element, wherein the web content includes a reference to an implementation of the custom web element. For example, the selected element can reference a modular and custom user interface component implemented within the web application. In some embodiments, the indication is initiated by a user selecting the element using a mouse or another similar pointer device. The selection can be initiated with the element evaluation extension activated from within the client browser. For example, a user enables the element evaluation extension from the browser and actively selects a web element such as a user interface element. In some embodiments, the element evaluation extension provides a user interface to acknowledge the received indication. In some embodiments, the indication received can correspond to any element of the web application and/or elements other than user interface elements. For example, the indication received is not limited to user interface elements or elements with a user interface component.

At 503, element attributes are provided. For example, attributes associated with the desired element are provided. In some embodiments, the attributes are provided by building a tree representation of the web content, wherein the user interface element of the indication received at 501 is associated with a node of the tree representation. For example, the tree representation of the web content can correspond to a Document Object Tree corresponding to the Document Object Model (DOM) for the current web page. In some embodiments, the attributes are provided by parsing the DOM for the current web page. For example, the web page can be loaded and parsed into a tree-like structure such as a Document Object Tree. The node associated with the element can be identified and the element attributes of the node can be retrieved and provided. In some embodiments, a set of default attributes are used, and the default attributes are provided. In some embodiments, all attributes associated with the element are provided. For example, the attributes associated with the user interface element can be automatically identified and provided, for example, by traversing a tree representation of the web application. In some embodiments, all attributes associated with a portion of the web application, such as the current web page or a set of web pages, are provided. The element attributes can be provided at 503 for determining a set of unique element attributes at 505 to uniquely identify the desired element. In various embodiments, the provided elements can be displayed in a user interface of and/or managed by the element evaluation extension. For example, the element evaluation extension can provide a listing of determined element attributes including automatically identified attributes for the element.

At 505, a set of unique element attributes is determined. For example, using the element attributes provided at 503, a set of unique attributes is determined that uniquely identifies the desired element. In some embodiments, a user interface of the element evaluation extension provides an indication of whether a current selection of attributes uniquely identifies the desired element. For example, a user interface of and/or managed by the element evaluation extension can provide the number of elements that match a current selection of attributes. The user can utilize this count or number indicator to add and/or remove attributes from the set of selected attributes until a unique set of element attributes is determined. In some embodiments, the set of unique element attributes is automatically determined and/or suggested by the element evaluation extension. For example, a set can be automatically determined, and the user can adjust the set as desired, such as by removing and/or adding attributes. In some embodiments, the set of attributes can include a route or path to the element, such as an absolute or relative path to the element or element node.

At 507, an identifier for the user interface element is generated using the determined attributes set. For example, using the set of unique element attributes determined at 505, an identifier is generated that uniquely identifies the desired user interface element. The ability to determine a unique identifier based on element attributes selected from within a web browser executing the web application allows users to easily and repeatedly locate a web element among the many others used in the web application. In some embodiments, the identifier is a unique locator or unique locator identifier. In various embodiments, the identifier may utilize a string format and/or another format compatible with programming code. For example, the identifier can be used within programming code of a supported programming language to uniquely identify the element and/or for binding functionality to the desired element and only to the desired element. The functionality bound to the element can be used to modify the behavior of the element including to test and/or validate the functionality of the element.

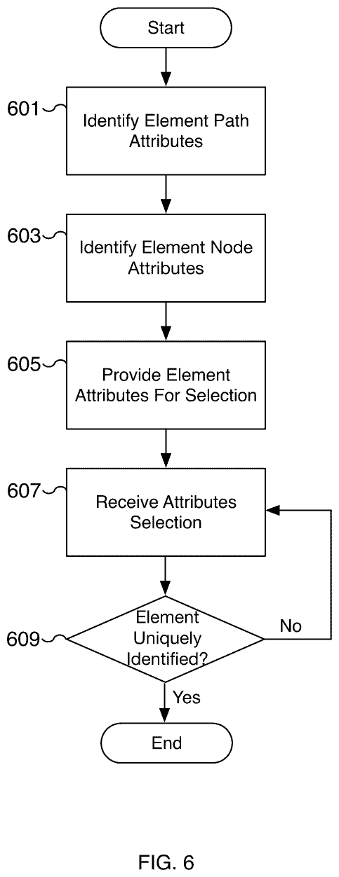

FIG. 6 is a flow chart illustrating an embodiment of a process for selecting a set of attributes for identifying an element of a web application. For example, using the process of FIG. 6, a user such as a web developer or engineer can select attributes from within a web browser to uniquely identify and evaluate a web application element. In various embodiments, the selection process can be automated and/or can be performed interactively and dynamically by the user. In some embodiments, the process is performed using an element evaluation extension installed with the client browser accessing the web application. For example, a user can be guided using an interactive user interface for determining the set of selected element attributes. Although the steps of FIG. 6 may be at times described with respect to a user interface element, the process is not limited to elements with or associated with a user interface and is applicable to other types of web elements of the web application. In some embodiments, the process of FIG. 6 is performed at 405 of FIG. 4 and/or at 503 and/or 505 of FIG. 5. In some embodiments, the process of FIG. 6 may be performed at least in part by an element evaluation browser extension such as element evaluation extension 221 of FIG. 2 and/or by an element evaluation module such as element evaluation module 315 of FIG. 3.

At 601, element path attributes are identified. For example, attributes associated with the path (or route) of the element are identified. The identified path attributes can be relative or absolute paths. In some embodiments, the identified paths correspond to a location of a node associated with the element within a tree representation of the web content, such as the path to the element's node within the Document Object Model (DOM) or Document Object Tree of the web content.

At 603, element node attributes are identified. For example, attributes associated with the element's node are identified. In some embodiments, the element node attributes are extracted by parsing the web content to create a tree representation of the web content and then traversing the tree until the element's node is reached. In some embodiments, the element attributes are retrieved using a Document Object Model (DOM) interface that allows the element evaluation extension to retrieve the element node attributes.

At 605, element attributes are provided for selection. For example, the attributes identified at 601 and/or at 603, such as the element path and/or element node attributes, are provided for selection. In some embodiments, the element attributes identified are provided via a user interface for and/or managed by the element evaluation extension. For example, the identified elements can be displayed via a user interface and made available to the user for selection. The user interface can be integrated into the element evaluation extension and/or the client browser, as appropriate. In some embodiments, a default selection of identified elements may be made and/or may be pre-selected. In some embodiments, a selection of identified elements is automatically determined, for example, by a configuration preference, by the element evaluation extension, and/or by the server-side element evaluation module.

At 607, a selection of attributes is received. For example, a selection of one or more element attributes is received. The attributes received may be selected by a user, such as by a web developer or engineer, for identifying and/or locating the web element within the web applications and for binding the element to functionality including server-side functionality. In some embodiments, the selection is automated and/or a default suggestion is provided. For example, a selection of identified elements can be automatically determined by a configuration preference, by the element evaluation extension, and/or by the server-side element evaluation module. In particular scenarios, the selection at this stage may not uniquely identify the element and may require additional refinement before an identifier for the element can be generated using the selected set of element attributes.

At 609, a determination is made whether the element is uniquely identified. For example, a determination is made whether the selection of attributes received at 607 uniquely identifies the element. In the event the element is uniquely identified, processing completes, and the selected set of attributes may be provided as a result. In the event the element is not uniquely identified, processing loops back to 607 where a new selection of attributes is received. For example, processing can loop back to 607, where the user and/or element evaluation extension can provide a new set of attributes for identifying the desired element.

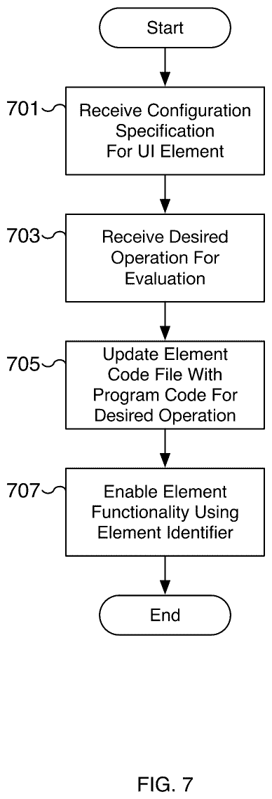

FIG. 7 is a flow chart illustrating an embodiment of a process for modifying the behavior of an identified web application element. For example, using the process of FIG. 7, the behavior of an identified web element, such as the associated server-side functionality of the element, can be modified. In some embodiments, the element is identified from within a remote client browser. Once a web element is identified, the intended behavior expressed as a desired operation and associated configurations can be provided from the remote client to a server-side component along with an element identifier. For example, the process of FIG. 7 can be initiated by an element evaluation extension of a client browser while running the web application. A corresponding server-side element evaluation module of a web applications platform communicates with an element evaluation extension for performing the process of FIG. 7 using the provided configuration specification and desired modifications. Although the steps of FIG. 7 may be at times described with respect to a user interface element, the process is not limited to elements with or associated with a user interface and is applicable to other types of web elements of the web application. In some embodiments, the process of FIG. 7 is performed at 407 and/or 409 of FIG. 4. In some embodiments, the process of FIG. 7 is implemented as one or more web services by web applications platform service 111 of FIG. 1 and/or web applications platform service 301 of FIG. 3, the associated web application hosting module is web application hosting module 311 of FIG. 3, and the associated element evaluation module is element evaluation module 315 of FIG. 3. In some embodiments, the remote client corresponds to clients 101, 103, and/or 105 of FIG. 1 and/or client 201 of FIG. 2, and the element evaluation browser extension is element evaluation extension 221 of FIG. 2.

At 701, a configuration specification for a user interface element is received. For example, a specification describing the configuration to associate with the intended user interface element is received. In some embodiments, the specification includes project and/or code file properties such as a path and file name to a project and corresponding code file for integrating the new desired operation for the element. The received specification can be provided from within a web browser by a user such as via an element evaluation browser extension. Providing the received specification remotely from the client browser allows the user to remain within the context of the web application and significantly improves the ability for the user to rapidly identify an element while also removing the requirement that the user has significant technical knowledge on web development and web application frameworks. The received specification can further include a method name and class for the addition/instrumentation, an element identifier or unique locator identifier, event triggers for the element, driver paths, application programming interface (API) endpoints, etc. In various embodiments, the configuration specification can include configurable parameters provided by the user via the element evaluation browser extension. In some embodiments, a specification for an API associated with the user interface element is received in response to receiving at least a portion of the configuration specification describing an API. For example, in response to receiving an API endpoint, the corresponding specification for the API associated with the user interface element can be retrieved. In some embodiments, a description of the retrieved API specification can be provided to the user via the element evaluation extension.

At 703, a desired operation for evaluation is received. For example, an operation describing a behavior or functionality to bind to the element is received. In various embodiments, the received desired operation will be evaluated for execution based on the triggering of an event such as a click or page load event, among other events available for configuration. The desired event trigger can be included in the configuration specification received at 701 and/or as part of the desired operation received at 703. In some embodiments, the desired operation corresponds to program code, such as Java programming code or a description of program code including pseudo code, that implements testing and/or validation functionality. For example, the desired operation can include one or more assert or assertion functions to validate one or more values associated with a user interface element. In various embodiments, the received operation can be provided from within a web browser by a user such as via an element evaluation browser extension. Providing the received operation remotely from the client browser allows the user to remain within the context of the web application and significantly improves the ability for the user to rapidly augment the functionality of a selected element while also removing the requirement that the user has significant technical knowledge on web development and web application frameworks.

At 705, the element program code file is updated with program code for the desired operation. For example, a code file associated with the element hosted by a web applications platform is updated to include program code implementing the desired operation. In various embodiments, the program code is inserted into the code file and bound to the desired element. The program code may be generated based on the provided configuration specification and desired operation received at 701 and/or 703, respectively. For example, a description (such as a name, path, and/or route, etc.) for accessing the code file can be received as part of the configuration specification received at 701 and the programming code or a description of the programming code corresponding to the desired operation can be received at 703. In some embodiments, the code is generated based on the provided parameters and the generated code is provided to the user for display, such as via the element evaluation browser extension. For example, from within the browser, a user or developer can interact with a displayed version of the program code used to implement the desired operation. In various embodiments, the program code file for the element is stored on a server that is remote from the client and the client web browser used to access and view the web application. For example, the program code file can be hosted by the web applications platform hosting the web application.

At 707, the element functionality is enabled using the element identifier. For example, the updated program code file and associated functionality is enabled for execution by binding the functionality to an element identifier. For example, a unique identifier of the element can be used to enable the functionality of the desired operation and associated program code to only the intended user interface element. In various embodiments, the unique identifier is used to uniquely identify the desired web element from other elements of the web application. By binding the desired operation to the element identifier, the functionality is only enabled for the intended element and not for any of the other elements of the web application. In some embodiments, the element identifier is received at 701 as part of the configuration specification and/or at 703 as part of the desired operation.

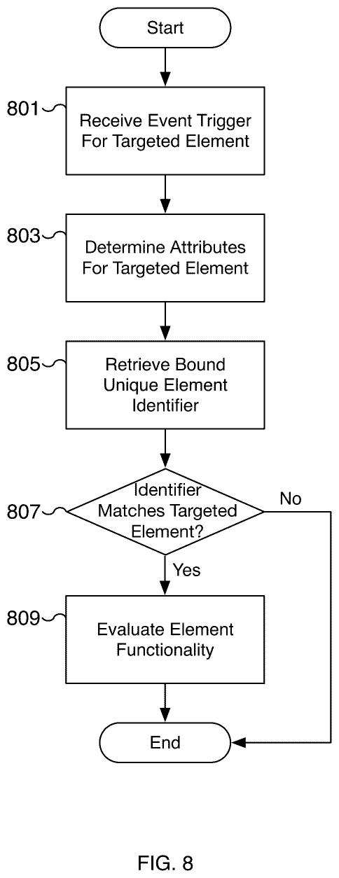

FIG. 8 is a flow chart illustrating an embodiment of a process for evaluating an element of a hosted web application. For example, using the process of FIG. 8, a user such as a web developer or engineer can dynamically modify the behavior of an identified web element and evaluate the element using the desired behavior. In some embodiments, the evaluation of the element includes executing an operation bound to the element based on an event trigger. For example, while accessing a web application from a client browser, a user can add a new behavior to an element and evaluate the element using the newly added behavior from within the user's operating context of the web browser. In some embodiments, the functionality is performed within the browser using an element evaluation extension. Although the steps of FIG. 8 may be at times described with respect to a user interface element, the process is not limited to elements with or associated with a user interface and is applicable to other types of web elements of the web application. In some embodiments, the process of FIG. 8 is performed at 409 of FIG. 4. In some embodiments, the process of FIG. 8 may be performed at least in part by a server-side element evaluation module such as element evaluation module 315 of FIG. 3. In some embodiments, the process of FIG. 8 is implemented and offered as one or more web services such as by web applications platform service 111 of FIG. 1 and/or web applications platform service 301 of FIG. 3. In some embodiments, the process of FIG. 8 can be initiated by a remote client such as clients 101, 103, and/or 105 of FIG. 1 and/or client 201 of FIG. 2, and may be initiated using an element evaluation browser extension such as element evaluation extension 221 of FIG. 2.

At 801, an event trigger is received for a targeted element. For example, an action that occurs in a web page and/or with respect to a web application is detected and a corresponding event trigger is initiated. Example events can include mouse events, keyboard events, device events, touch events, form events, load events, and resize events, among others. In various embodiments, the event can be initiated by the user, the client system, a network response, web application functionality and programming logic, and/or another source and directed at one or more targeted elements. For example, an event, such as a touch event, can be directed at a target button element. In some embodiments, the event may be propagated through an element hierarchy such as up a Document Object Model (DOM). For example, an event trigger can be first associated with an initial element and then bubbled up to each of its ancestors allowing multiple elements, including elements at different levels of the DOM tree, to handle the same event. In various embodiments, at 801, the event trigger is directed for a specific target element within the applicable element hierarchy. In some embodiments, multiple passes of the process of FIG. 8 can be performed for the same event but for different elements, for example, if the event is allowed to propagate from a lower target element up the element hierarchy.

At 803, attributes for the targeted element are determined. For example, the element targeted at 801 is analyzed to retrieve the attributes associated with the element. In some embodiments, the attributes are extracted from the Document Object Model (DOM). The attributes can include element node attributes and element path attributes. For example, element node attributes can include the attributes associated with the element's node within a Document Object Tree (DOT) and element path attributes can include the path or route of the element's node within the DOT.

At 805, a bound unique element identifier is retrieved. For example, a unique identifier bound to an element configured for evaluation is retrieved. In various embodiments, the element identifier can be determined by a selection process when accessing the web application from a browser. For example, a user can select the desired element for evaluation and an identifier or unique locator identifier is determined and bound to the element along with a desired operation. At 805, a unique element identifier is retrieved that can uniquely identify the desired element from other elements used by the web application. In some embodiments, the element identifier is inserted into an event handler of a code file for processing the event trigger received at 801.

At 807, a determination is made whether the element identifier matches the targeted element. For example, the element targeted for the event trigger at 801 and its attributes determined at 803 are compared to the unique element identifier retrieved at 805. In the event the element identifier matches the targeted element, processing proceeds to 809. For example, a determination is made that the element identifier matches the targeted element based on the determined attributes of the targeted element, and as a result of the match, processing proceeds to 809 where the targeted element is evaluated for a desired operation. In the event the identifier does not match the targeted element, processing completes. For example, the targeted element does not match the desired element configured for evaluation and therefore the desired operation is not evaluated for the targeted element. In some embodiments, the event trigger may be processed for other elements, for example, in the event other elements are also configured for evaluation.

At 809, element functionality is evaluated. For example, functionality associated with a desired operation configured for the element is evaluated. The functionality can be previously configured by a user accessing the web application and can be performed in real-time and dynamically from within the browser application. The evaluation can include testing and valuation code such as assert and/or debugging methods to confirm the correctness of one or more values associated with the element. In various embodiments, the executed functionality test is used to test the correctness of the programmed functionality associated with the element as part of a testing and/or validation process. In some embodiments, results of the evaluated functionality are displayed to the user, for example, via an element evaluation browser extension. For example, the element functionality can output results to a results user interface panel accessible via the browser allowing the user to confirm in real time the results of the evaluated element.

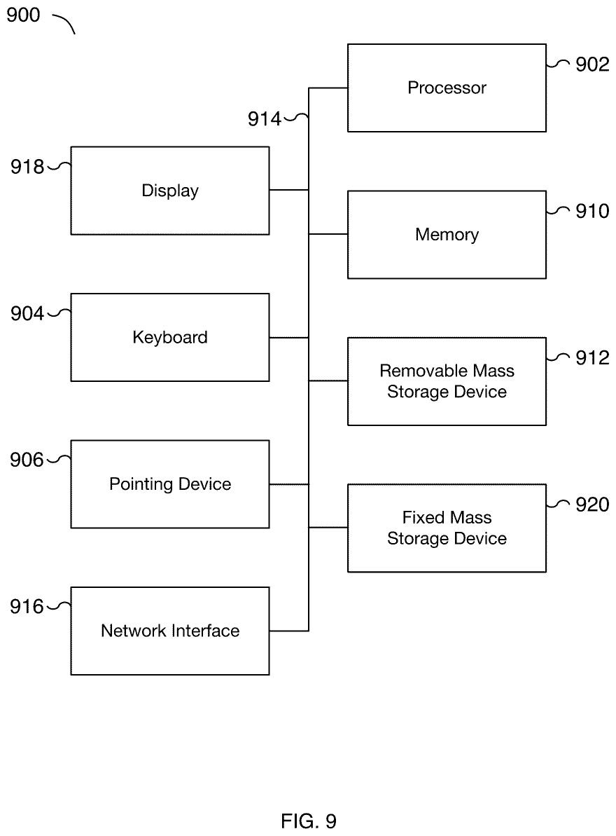

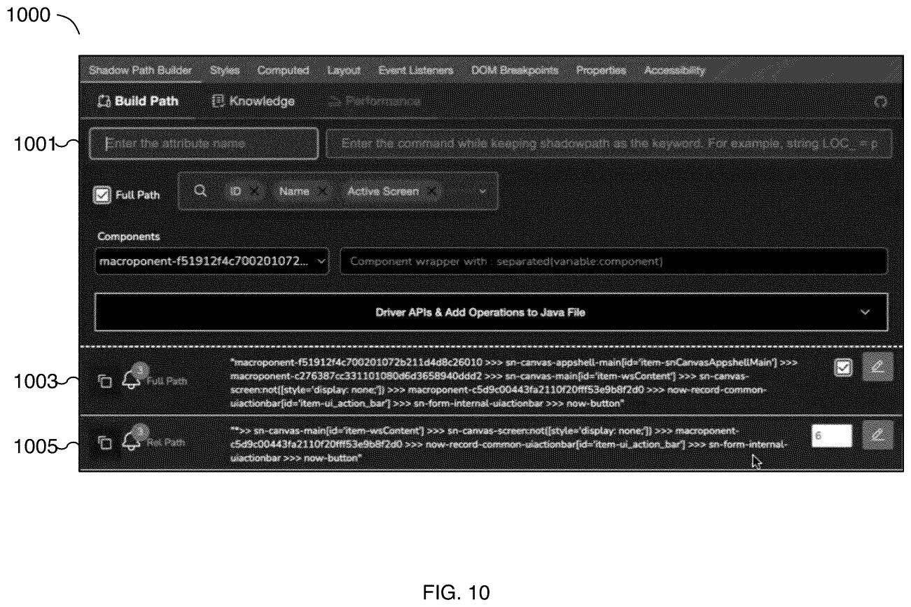

FIG. 9 is a functional diagram illustrating a programmed computer system for the evaluation of web application elements. As will be apparent, other computer system architectures and configurations can be utilized for the evaluation of web elements including the interactive evaluation of web elements. Examples of computer system 900 include clients 101, 103, and 105 of FIG. 1, one or more computers of web applications platform service 111 of FIG. 1, client 201 of FIG. 2, and/or one or more computers of web applications platform service 301 of FIG. 3. Computer system 900, which includes various subsystems as described below, includes at least one microprocessor subsystem (also referred to as a processor or a central processing unit (CPU)) 902. For example, processor 902 can be implemented by a single-chip processor or by multiple processors. In some embodiments, processor 902 is a general purpose digital processor that controls the operation of the computer system 900. Using instructions retrieved from memory 910, the processor 902 controls the reception and manipulation of input data, and the output and display of data on output devices (e.g., display 918). In various embodiments, one or more instances of computer system 900 can be used to implement at least portions of the processes of FIGS. 4-8 and the functionality associated with the diagrams of FIGS. 10-13.

Processor 902 is coupled bi-directionally with memory 910, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 902. Also as is well known in the art, primary storage typically includes basic operating instructions, program code, data and objects used by the processor 902 to perform its functions (e.g., programmed instructions). For example, memory 910 can include any suitable computer-readable storage media, described below, depending on whether, for example, data access needs to be bi-directional or unidirectional. For example, processor 902 can also directly and very rapidly retrieve and store frequently needed data in a cache memory (not shown).

A removable mass storage device 912 provides additional data storage capacity for the computer system 900, and is coupled either bi-directionally (read/write) or unidirectionally (read only) to processor 902. For example, storage 912 can also include computer-readable media such as magnetic tape, flash memory, PC-CARDS, portable mass storage devices, holographic storage devices, and other storage devices. A fixed mass storage 920 can also, for example, provide additional data storage capacity. The most common example of mass storage 920 is a hard disk drive. Mass storages 912, 920 generally store additional programming instructions, data, and the like that typically are not in active use by the processor 902. It will be appreciated that the information retained within mass storages 912 and 920 can be incorporated, if needed, in standard fashion as part of memory 910 (e.g., RAM) as virtual memory.

In addition to providing processor 902 access to storage subsystems, bus 914 can also be used to provide access to other subsystems and devices. As shown, these can include a display monitor 918, a network interface 916, a keyboard 904, and a pointing device 906, as well as an auxiliary input/output device interface, a sound card, speakers, and other subsystems as needed. For example, the pointing device 906 can be a mouse, stylus, track ball, or tablet, and is useful for interacting with a graphical user interface.

The network interface 916 allows processor 902 to be coupled to another computer, computer network, or telecommunications network using a network connection as shown. For example, through the network interface 916, the processor 902 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 902 can be used to connect the computer system 900 to an external network and transfer data according to standard protocols. For example, various process embodiments disclosed herein can be executed on processor 902, or can be performed across a network such as the Internet, intranet networks, or local area networks, in conjunction with a remote processor that shares a portion of the processing. Additional mass storage devices (not shown) can also be connected to processor 902 through network interface 916.

An auxiliary I/O device interface (not shown) can be used in conjunction with computer system 900. The auxiliary I/O device interface can include general and customized interfaces that allow the processor 902 to send and, more typically, receive data from other devices such as microphones, touch-sensitive displays, transducer card readers, tape readers, voice or handwriting recognizers, biometrics readers, cameras, portable mass storage devices, and other computers.

In addition, various embodiments disclosed herein further relate to computer storage products with a computer readable medium that includes program code for performing various computer-implemented operations. The computer-readable medium is any data storage device that can store data which can thereafter be read by a computer system. Examples of computer-readable media include, but are not limited to, all the media mentioned above: magnetic media such as hard disks, floppy disks, and magnetic tape; optical media such as CD-ROM disks; magneto-optical media such as optical disks; and specially configured hardware devices such as application-specific integrated circuits (ASICs), programmable logic devices (PLDs), and ROM and RAM devices. Examples of program code include both machine code, as produced, for example, by a compiler, or files containing higher level code (e.g., script) that can be executed using an interpreter.

The computer system shown in FIG. 9 is but an example of a computer system suitable for use with the various embodiments disclosed herein. Other computer systems suitable for such use can include additional or fewer subsystems. In addition, bus 914 is illustrative of any interconnection scheme serving to link the subsystems. Other computer architectures having different configurations of subsystems can also be utilized.

FIG. 10 is a diagram illustrating an embodiment of a user interface for an element evaluation browser extension. In the example shown, user interface 1000 is a user interface for an element evaluation browser extension that allows a user, such as a web developer or engineer, to select an element for evaluation. User interface 1000 includes multiple user interface components including element attribute name dialog component 1001, full element path component 1003, and relative element path component 1005, among others that are not labeled. In the example of FIG. 10, a web element of a web application has been selected from within the associated browser, and user interface 1000 is provided to the user to assist in selecting attributes for identifying the selected element. For example, element attribute name component 1001 (shown with focus but without an entry) allows the user to enter an attribute of the selected element for inclusion in the set of selected attributes. As shown in user interface 1000, the current set of attributes that are selected include the attributes: “ID,” “Name,” and “Active Screen.” Additionally, user interface 1000 shows that the element's full path attribute is selected as an alternative to a relative path for the element. On the lower portion of user interface 1000, FIG. 10 shows an example of a retrieved full path for the selected web element using full element path component 1003, and a corresponding retrieved relative path for the selected web element using relative element path component 1005. As shown in FIG. 10, the relative element is typically shorter and therefore more compressed than the full path. In various embodiments, the relative element path can be configured to utilize a configured number of fields, such as 6, as shown in relative element path component 1005. In some embodiments, user interface 1000 is provided by element evaluation extension 221 of FIG. 2 and is used in part to implement the processes of FIGS. 4-8.

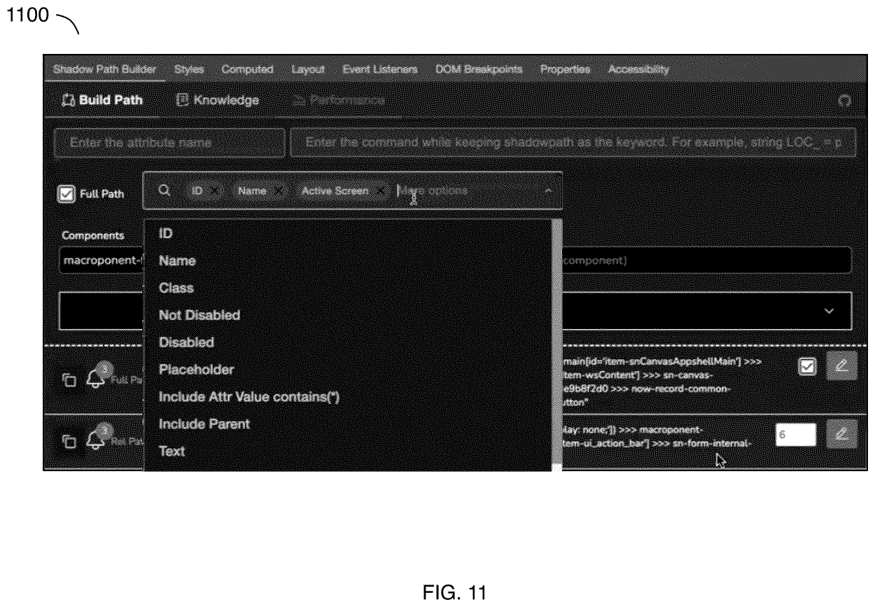

FIG. 11 is a diagram illustrating an embodiment of a user interface for an element evaluation browser extension. In the example shown, user interface 1100 is a user interface for an element evaluation browser extension that allows a user, such as a web developer or engineer, to select an element for evaluation. With respect to FIG. 11, user interface 1100 provides the user with a user interface for selecting among determined relevant attributes for the selected web element. User interface 1100 includes multiple user interface components and corresponds to user interface 1000 of FIG. 10 but with a selected element attributes component in focus. In the example shown, the selected element attributes component displays existing selected elements (“ID,” “Name,” and “Active Screen”) and allows the user to select additional attributes from a populated listing as well as to remove any of the selected attributes (for example, by selecting the “X” associated with a selected attribute). As shown in FIG. 11, the selected element attributes component is prepopulated with available and/or relevant attributes for the selected web element. For example, a partial list of available and/or relevant attributes shown in FIG. 11 include “ID,” “Name,” “Class,” “Not Disabled,” “Disabled,” “Placeholder,” “Include Attr Value contains(*),” “Include Parent,” and “Text” attributes. In some embodiments, user interface 1100 is provided by element evaluation extension 221 of FIG. 2 and is used in part to implement the processes of FIGS. 4-8.

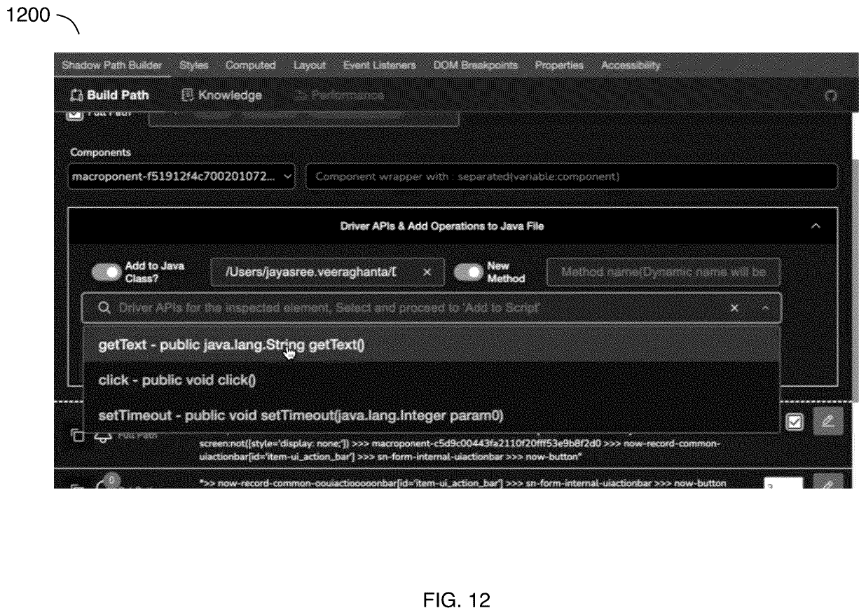

FIG. 12 is a diagram illustrating an embodiment of a user interface for an element evaluation browser extension. In the example shown, user interface 1200 is a user interface for an element evaluation browser extension that allows a user, such as a web developer or engineer, to select an element for evaluation. With respect to FIG. 12, user interface 1200 provides the user with a user interface for providing parameters related to a configuration specification of a desired operation for evaluation for the selected web element. User interface 1200 includes multiple user interface components and corresponds to user interface 1000 of FIG. 10 and/or user interface 1100 of FIG. 11 but with portions related to configuring a web driver and an element evaluation operation in focus. In the example shown, components of user interface 1200 allow the user to specify a method to bind to the selected web element for evaluation. The selected method can include existing methods associated with a configured web driver as well as new methods. Examples of existing methods exposed by the driver application programming interface (API) include “getText,” “click,” and “setTimeout.” In various embodiments, user interface 1200 also allows a user to specify configuration parameters of an associated programming language class (such as a Java class). The parameters can include a corresponding program project and code file for the selected method. In various embodiments, using the functionality exposed by user interface 1200, a user can at least in part configure a desired operation and/or behavior to evaluate for the selected web element. In some embodiments, user interface 1200 is provided by element evaluation extension 221 of FIG. 2 and is used in part to implement the processes of FIGS. 4-8.

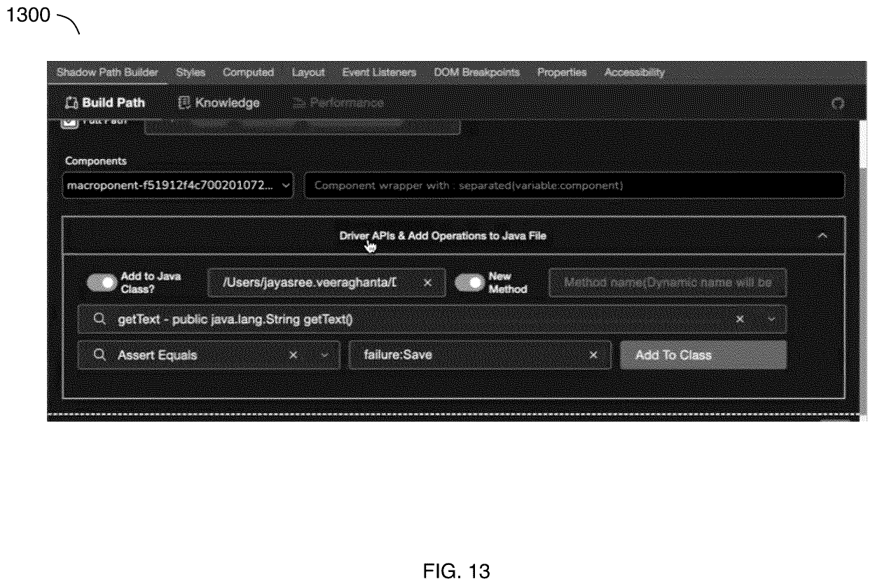

FIG. 13 is a diagram illustrating an embodiment of a user interface for an element evaluation browser extension. In the example shown, user interface 1300 is a user interface for an element evaluation browser extension that allows a user, such as a web developer or engineer, to select an element for evaluation. With respect to FIG. 13, user interface 1300 provides the user with a user interface for providing parameters related to a configuration specification of a desired operation for evaluation for the selected web element. User interface 1300 includes multiple user interface components and corresponds to user interface 1000 of FIG. 10, user interface 1100 of FIG. 11, and/or user interface 1200 of FIG. 12 but with portions related to configuring an element evaluation operation in focus, completed, and ready for confirmation. In the example shown, and similar to user interface 1200 of FIG. 12, components of user interface 1300 allow the user to specify a method to bind to the selected web element for evaluation. As shown in FIG. 13, a getText method with an Assert Equals operation is configured for a selected web element. The configured functionality will be added to the provided Java class code file. Once configured, when the associated event is triggered (such as a page load event that is not shown), the web element will be evaluated with the configured operation. In some embodiments, user interface 1300 is provided by element evaluation extension 221 of FIG. 2 and is used in part to implement the processes of FIGS. 4-8.

One aspect of the disclosure includes a method for receiving, from a client, an indication of a user interface element associated with corresponding web content; determining an identifier associated with the user interface element based at least in part on one or more attributes associated with the user interface element; receiving a specification of a code file and an operation; and generating for the code file, program code to perform the operation on the user interface element referenced by the identifier. Implementations of the disclosure may include one or more of the following optional features including wherein the identifier corresponds to a path to the user interface element; receiving the one or more attributes associated with the user interface element from the client; wherein the user interface element corresponds to a button, an image, or a form; wherein the user interface element corresponds to a custom web element, wherein the web content includes a reference to an implementation of the custom web element; automatically identifying a plurality of attributes associated with the user interface element; providing for display at least one of the identified plurality of attributes associated with the user interface element; receiving one or more values associated with the plurality of the attributes associated with the user interface element, wherein the received one or more values are used to uniquely identify the user interface element; building a tree representation of the web content, wherein the user interface element of the web content is associated with a node of the tree representation of the web content; retrieving a specification for an application programming interface associated with the indicated user interface element; providing for display the generated program code; and/or wherein the code file is stored on a remote server located remotely from a web browser used to view the web content

Another aspect of the disclosure provides a system with one or more processors and a memory coupled to the one or more processors, wherein the memory is configured to provide the one or more processors with instructions which when executed cause the one or more processors to: receive, from a client, an indication of a user interface element associated with corresponding web content; determine an identifier associated with the user interface element based at least in part on one or more attributes associated with the user interface element; receive a specification of a code file and an operation; and generate for the code file, program code to perform the operation on the user interface element referenced by the identifier. This aspect may include one or more of the following optional features including wherein the identifier corresponds to a path to the user interface element; wherein the memory is further configured to provide the one or more processors with instructions which when executed cause the one or more processors to: receive the one or more attributes associated with the user interface element from the client; wherein the user interface element corresponds to a button, an image, or a form; wherein the user interface element corresponds to a custom web element, wherein the web content includes a reference to an implementation of the custom web element; wherein the memory is further configured to provide the one or more processors with instructions which when executed cause the one or more processors to: automatically identify a plurality of attributes associated with the user interface element; and wherein the memory is further configured to provide the one or more processors with instructions which when executed cause the one or more processors to: receive one or more values associated with the plurality of the attributes associated with the user interface element, wherein the received one or more values are used to uniquely identify the user interface element.

In various embodiments, the disclosed invention may also be implemented as a computer program product, the computer program product being embodied in a non-transitory computer readable storage medium and comprising computer instructions for: receiving, from a client, an indication of a user interface element associated with corresponding web content; determining an identifier associated with the user interface element based at least in part on one or more attributes associated with the user interface element; receiving a specification of a code file and an operation; and generating for the code file, program code to perform the operation on the user interface element referenced by the identifier. The details of one or more implementations of the disclosure are set forth in the accompanying drawings and description. Other aspects, features, and advantages will be apparent from the description and drawings, and from the claims.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method comprising:
receiving, from a client, an indication of a user interface element associated with corresponding web content;
determining an identifier associated with the user interface element based at least in part on one or more attributes associated with the user interface element;
receiving a specification of a code file and an operation; and
generating for the code file, program code to perform the operation on the user interface element referenced by the identifier.

2. The method of claim 1, wherein the identifier corresponds to a path to the user interface element.

3. The method of claim 1, further comprising receiving the one or more attributes associated with the user interface element from the client.

4. The method of claim 1, wherein the user interface element corresponds to a button, an image, or a form.

5. The method of claim 1, wherein the user interface element corresponds to a custom web element, wherein the web content includes a reference to an implementation of the custom web element.

6. The method of claim 1, further comprising automatically identifying a plurality of attributes associated with the user interface element.

7. The method of claim 6, further comprising providing for display at least one of the identified plurality of attributes associated with the user interface element.

8. The method of claim 6, further comprising receiving one or more values associated with the plurality of the attributes associated with the user interface element, wherein the received one or more values are used to uniquely identify the user interface element.

9. The method of claim 1, further comprising building a tree representation of the web content, wherein the user interface element of the web content is associated with a node of the tree representation of the web content.

10. The method of claim 1, further comprising retrieving a specification for an application programming interface associated with the indicated user interface element.

11. The method of claim 1, further comprising providing for display the generated program code.

12. The method of claim 1, wherein the code file is stored on a remote server located remotely from a web browser used to view the web content.

13. A system comprising:
one or more processors; and
a memory coupled to the one or more processors, wherein the memory is configured to provide the one or more processors with instructions which when executed cause the one or more processors to:
receive, from a client, an indication of a user interface element associated with corresponding web content;
determine an identifier associated with the user interface element based at least in part on one or more attributes associated with the user interface element;
receive a specification of a code file and an operation; and
generate for the code file, program code to perform the operation on the user interface element referenced by the identifier.

14. The system of claim 13, wherein the identifier corresponds to a path to the user interface element.

15. The system of claim 13, wherein the memory is further configured to provide the one or more processors with instructions which when executed cause the one or more processors to:
receive the one or more attributes associated with the user interface element from the client.

16. The system of claim 13, wherein the user interface element corresponds to a button, an image, or a form.

17. The system of claim 13, wherein the user interface element corresponds to a custom web element, wherein the web content includes a reference to an implementation of the custom web element.

18. The system of claim 13, wherein the memory is further configured to provide the one or more processors with instructions which when executed cause the one or more processors to: automatically identify a plurality of attributes associated with the user interface element.

19. The system of claim 18, wherein the memory is further configured to provide the one or more processors with instructions which when executed cause the one or more processors to: receive one or more values associated with the plurality of the attributes associated with the user interface element, wherein the received one or more values are used to uniquely identify the user interface element.

20. A computer program product, the computer program product being embodied in a non-transitory computer readable storage medium and comprising computer instructions for:
receiving, from a client, an indication of a user interface element associated with corresponding web content;
determining an identifier associated with the user interface element based at least in part on one or more attributes associated with the user interface element;
receiving a specification of a code file and an operation; and
generating for the code file, program code to perform the operation on the user interface element referenced by the identifier.
